(19) United States
(12) Patent Application Publication
(10) Pub. No.: US 2014/0192375 A1
(43) Pub. Date: Jul. 10, 2014

(54) IMAGE FORMING APPARATUS AND IMAGE FORMING METHOD

(71) Applicant: Konica Minolta , Inc., Tokyo (JP)

(72) Inventor: Keisuke MORITA, Tokyo (JP)

(73) Assignee: Konica Minolta , Inc., Tokyo (JP)

(21) Appl. No.: 14/108,525

(22) Filed: Dec. 17, 2013

(30) Foreign Application Priority Data
Jan. 8, 2013 (JP) 2013-001404

(51) Int. Cl. H04N 1/00; G06K 15/02

(52) U.S. Cl. CPC H04N 1/00045; G06K 15/025
USPC 358/1.13

(57) ABSTRACT

An image forming apparatus includes an image forming unit that forms an image on a sheet on the basis of a job and a controller that manages the job and controls the formation of the image. The controller enables a sample discharge and determines whether to change a sample discharge interval which is set in the sample discharge on the basis of information related to the image when the job is executed.

### CROSS-REFERENCE TO RELATED APPLICATION

This application is based on Japanese Patent Application No. 2013-001404 filed with Japan Patent Office on Jan. 8, 2013, the entire content of which is hereby incorporated by reference.

### BACKGROUND OF THE INVENTION

1. Field of the Invention

The present invention relates to an image forming apparatus that forms an image on a sheet and outputs the sheet, and more particularly, to an image forming apparatus which can perform sample discharge.

2. Description of the Related Art

In an image forming apparatus which forms an image using image data and prints the image on a sheet, image quality varies over time and the user wants to check whether image quality reaches a predetermined value and to maintain the image quality.

From this point of view, an image forming apparatus has been proposed which can print an image that enables the user to check image quality before a usual printing operation or during printing. An output function for checking image quality is referred to as sample discharge. For example, printing is performed at the set time. In addition, an image forming apparatus has been known which can implement a check method that is called a proof function of printing copies one by one in order to check the finishing of printing.

For example, the sample discharge has the advantage that the user can check image quality, hut has the disadvantage that, due to the printing to sheets or reduction in operation rate of the main output, waste paper is generated or yield is reduced. In addition, when the sample discharge interval is increased to reduce the opportunity of the sample discharge, the above-mentioned problem is reduced, but an output check interval increases. As a result, the original function is impaired. For example, the following problem is considered: an unnecessary sample discharge is performed for a black-and-white text document page with a low image quality risk, or the deterioration of image quality is not checked due to an inappropriate sample discharge output time in a high density color-image page with a high image quality risk. In addition, the following problem is considered: an unnecessary sample discharge is performed during a stable output after start-up or the deterioration of image quality is not checked due to a long sample discharge interval during long-term running. Therefore, it is necessary to appropriately adjust the execution time in the sample discharge.

For example, Japanese Patent Application Laid-open No, 2011-189688 discloses an image forming apparatus that performs sample discharge for a page in which a color change is likely to occur and appropriately checks the finishing of printing.

In addition, Japanese Patent Application Laid-open No, 2010-72022 discloses an image forming apparatus which creates a residual function index value of a component of an image forming mechanism on the basis of the use of the component in an image forming process, stores the residual function index value, and can set a sample discharge interval on the basis of the residual function index value.

Japanese Patent Application Laid-open No. 2009-276585 discloses an image forming apparatus which appropriately adjusts the sample discharge time using, for example, environmental temperature, environmental humidity, the execution of a calibration process, and the execution of a toner replacement process as determination elements.

However, the image forming apparatus disclosed in Japanese Patent Application Laid-open No. 2011-189688 does not consider a change in the apparatus over time and it is difficult to appropriately set the sample discharge time.

The image forming apparatus disclosed in Japanese Patent Application Laid-open No. 2010-72022 considers a change in the apparatus over time. However, the image forming apparatus sets the sample discharge time on the basis of the assumed change and it is difficult to appropriately set the sample discharge time in correspondence with the actual change.

The image forming apparatus disclosed in Japanese Patent Application Laid-open No. 2009-276585 sets the sample discharge time on the basis of the state of the apparatus. However, the image forming apparatus sets the sample discharge time on the basis of the assumed state and it is difficult to set the sample discharge time in correspondence with, for example, the actual image or a change in image output over time.

### SUMMARY OF THE INVENTION

The present invention has been made in view of the above-mentioned problems and an object of the present invention is to provide an image forming apparatus and an image forming method which can Check a change in an actual image over time and appropriately set a sample discharge time.

To achieve at least one of the above-mentioned objects, an image forming apparatus reflecting one aspect of the present invention includes an image forming unit that forms an image on a sheet on the basis of a job and a controller that manages the job and controls the formation of the image. The controller enables a sample discharge and determines whether to change a sample discharge interval which is set in the sample discharge on the basis of information related to the image when the job is executed..

It is preferable that the image forming apparatus according to the above-mentioned aspect further include a document reading unit that reads a document image, and the information related to the image be related to the image read by the document reading unit.

In the image forming apparatus according to the above-mentioned aspect, it is preferable that the controller determine whether to change the sample discharge interval, using a change in predetermined information of the image in a predetermined unit of comparison as the information related to the image. In the image forming apparatus according to the above-mentioned aspect, it is preferable that, in a case where the job is set such that a plurality of copies of the image read by the document reading unit are output, when the output starts after the reading of the entire document is completed, the controller apply a change in the sample discharge interval to a first copy, and when the job is set such that the output starts while the document is being read, the controller apply the change in the sample discharge interval to a second copy.

It is preferable that the image forming apparatus according to the above-mentioned aspect further include an image detection unit that reads an output image of the sheet having the image formed thereon, and the information related to the image be related to the image read by the image detection unit.

In the image forming apparatus according to the above-mentioned aspect, it is preferable that the controller determine whether to change the sample discharge interval, using a change in predetermined information of the image in a predetermined unit of comparison as the information related to the image.

In the image forming apparatus according to the above-mentioned aspect, it is preferable that, when the job is to output a plurality of copies, the controller use the image read by the image detection unit as a reference image in a first copy, and in a second copy or subsequent copies, the controller compare the image read by the image detection unit with predetermined information of the reference image in a predetermined unit of comparison, and determine whether to change the sample discharge interval using the comparison result as the information related to the image.

In the image forming apparatus according to the above-mentioned aspect, it is preferable that the controller have a proof discharge function, use the image read by the image detection unit as a reference image in the proof discharge of the job, compare the image read by the image detection unit with predetermined information of the reference image in a predetermined unit of comparison, in the main output of the job, and determine whether to change the sample discharge interval using the comparison result as the information related to the image.

In the image forming apparatus according to the above-mentioned aspect, it is preferable that the controller print a density chart on a sheet when the job is executed, the image detection unit read the density chart, and the controller determine whether to change the sample discharge interval using a density change in the density chart as the information related to the image,

In the image forming apparatus according to the above-mentioned aspect, it is preferable that the controller determine to change the sample discharge interval to a smaller value when the density change is equal to or greater than a first predetermined value and determine to change the sample discharge interval to a larger value when the density change is less than a second predetermined value (where the first predetermined value is equal to or greater than the second predetermined value).

In the image forming apparatus according to the above-mentioned aspect, it is preferable that the controller determine whether there is a contamination in the image read by the image detection unit and determine to change the sample discharge interval to a smaller value when it is determined that there is a contamination.

In the image forming apparatus according to the above-mentioned aspect, it is preferable that the unit of comparison be a page or a copy.

In the image forming apparatus according to the above-mentioned aspect, it is preferable that the predetermined information be at least one of, an amount of attached toner, density, and the position of a register mark of each page.

In the image forming apparatus according to the above-mentioned aspect, it is preferable that the controller compare the Dumber of text pages with the number of photograph pages in the image included in the job, and the controller determine to change the sample discharge interval to a smaller value when the number of photograph pages is equal to or more than a first predetermined number of pages, and determine to change the sample discharge interval to a larger value when the number of photograph pages is less than a second predetermined number of pages (where the first predetermined number of pages is equal to or more than the second predetermined number of pages).

In the image forming apparatus according to the above-mentioned aspect, it is preferable that the controller determine whether to change the sample discharge interval using coverage of the job as the information related to the image.

In the image forming apparatus according to the above-mentioned aspect, it is preferable that, in a case where the job is related to a monochrome image, when it is determined that the coverage of the image included in the job is low and is equal to or less than a first predetermined monochrome coverage value, the controller determine to change the sample discharge interval to a smaller value, and when it is determined that the coverage is high and is greater than a second predetermined monochrome coverage value (where the first predetermined monochrome coverage value is equal to or less than the second predetermined monochrome coverage value), the controller determine to change the sample discharge interval to a larger value.

In the image forming apparatus according to the above-mentioned aspect, it is preferable that, in a case where the job includes a color image, when it is determined that the coverage of the image included in the job is high and is greater than a first predetermined color coverage value, the controller determine to change the sample discharge interval to a smaller value, and when it is determined that the coverage is low and is equal to or less than a second predetermined color coverage value (where the first predetermined color coverage value is equal to or greater than the second predetermined color coverage value), the controller determine to change the sample discharge interval to a larger value,

In the image forming apparatus according to the above-mentioned aspect, it is preferable that, during a change in the sample discharge interval, when the sample discharge interval is set to a sheet number cycle, the controller change a cyclic number of sheets. It is preferable that, when the sample discharge interval is set to a copy+page cycle, the controller change a cyclic number of copies, or the cyclic number of copies and the page cycle.

In the image forming apparatus according to the above-mentioned aspect, it is preferable that the controller perform control such that an operation of making a sample discharge interval change process available and an operation of making the sample discharge interval change process unavailable can be selected.

In the image forming apparatus according to the above-mentioned aspect, it is preferable that the controller change the sample discharge interval immediately after it is determined that the sample discharge interval is changed or when an instruction is received from an operator.

It is preferable that the image forming apparatus according to the above-mentioned aspect further include an operation unit that receives an operation input, and the controller perform control such that the sample discharge interval can be set by the operation unit.

To achieve at least one of the above mentioned objects, an image forming method of forming an image on a sheet on the basis of a job and enabling a sample discharge when the job is executed reflecting one aspect of the present invention includes acquiring information related to the image, and determining whether to change a sample discharge interval which is set in the sample discharge on the basis of the information related to the image.

### BRIEF DESCRIPTION OF THE DRAWINGS

FIG. 1 is a diagram schematically illustrating an image forming apparatus according to an embodiment of the invention;

FIG. 2 is a diagram illustrating a control block;

FIG. 3 is a diagram schematically illustrating an image forming apparatus according to another embodiment;

FIG. 4 is a diagram illustrating a sample discharge interval setting screen of the image forming apparatus according to the embodiment of the invention;

FIG. 5 is a diagram illustrating an image of an image list;

FIG. 6 is a flowchart illustrating a sample discharge process according to the related art;

FIG. 7 is a flowchart illustrating a process of changing a sample discharge interval on the basis of a document image in the embodiment of the invention;

FIG. 8 is a flowchart illustrating a process of changing the sample discharge interval on the basis of the image reading result of an in-line sensor using the periodic output result of a density chart;

FIG. 9 is a flowchart illustrating a process of changing the sample discharge interval on the basis of the determination whether there is a contamination in the image read by the in-line sensor;

FIG. 10 is a flowchart illustrating a process of changing the sample discharge interval on the basis of comparing reference data of the image read by the in-line sensor with target data for each page; and

FIG. 11 is a flowchart illustrating a process of changing the sample discharge interval on the basis of comparing the reference data of the image read by the in-line sensor with target data for each copy.

### DETAILED DESCRIPTION OF THE PREFERRED EMBODIMENTS

Hereinafter, an image forming apparatus 1 according to an embodiment of the invention will be described with reference to the accompanying drawings.

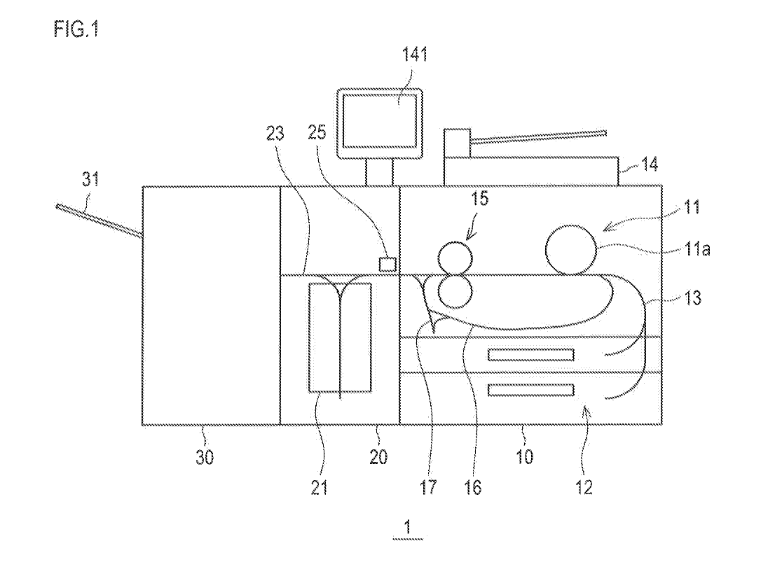

As shown in FIG. 1, in the image forming apparatus 1, an image forming apparatus body 10 which forms an image, a relay apparatus body 20, and a post-processing apparatus body 30 are connected in series to each other.

In the embodiments, the connection structure of the image forming apparatus is not limited thereto, but the image forming apparatus may include only the image forming apparatus body.

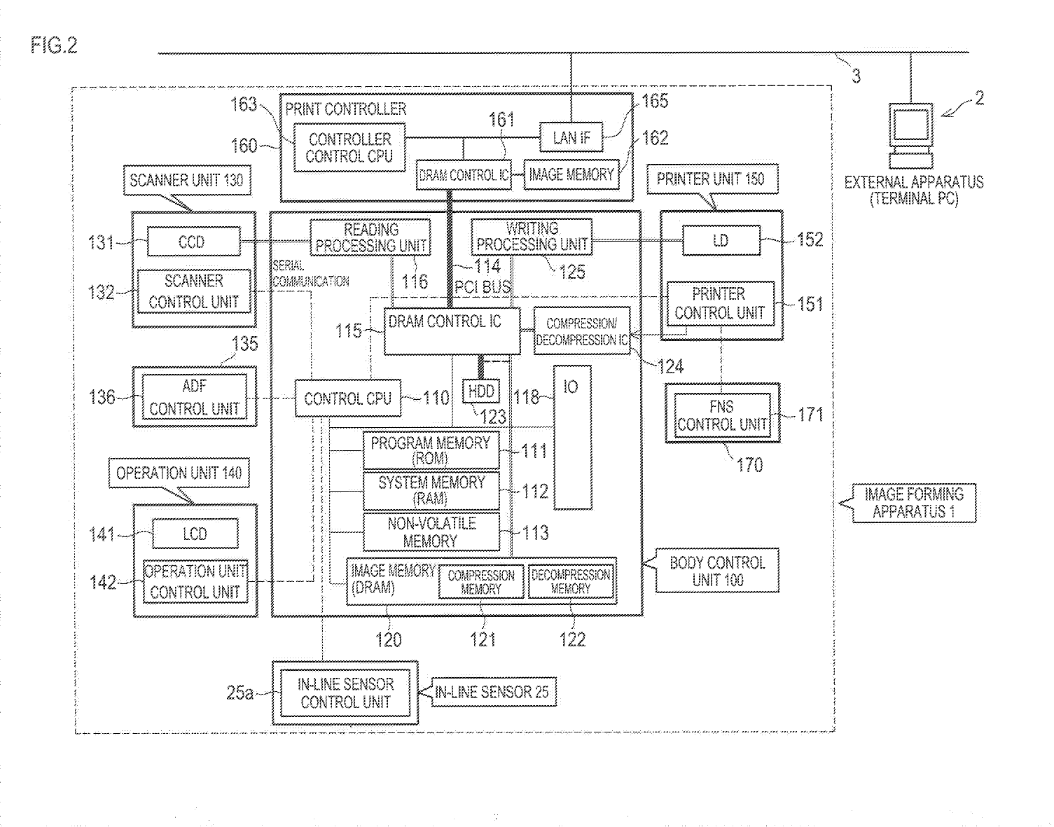

An automatic document feeder (ADF) 14 is provided in an upper part of the image forming apparatus body 10 and a scanner unit 130 shown in FIG. 2 can read the image of a document which is fed by the automatic document feeder (ADF) 14. The document can be read on a platen glass (not shown).

An LCD 141 of an operation unit 140 is provided in an upper part of the image forming apparatus body 10 or the relay apparatus body 20 at a position where the platen glass is not disposed. The LCD 141 includes a touch panel and can receive an operation of the operator and display information. The LCD 141 functions as both the operation unit and a display unit. The operation unit is, for example, a mouse or a tablet and can be provided separately from the display unit. The LCD 141 may be movable.

A plurality of paper feed trays 12 (two stages of paper feed trays in the drawings) are arranged in a lower part of the image forming apparatus body 10.

A transport path 13 through which a sheet fed from any one of the paper feed trays 12 is transported is provided in the image forming apparatus body 10 and an image forming unit 11 is provided in the transport path of the image forming apparatus body 10. The image forming unit 11 includes a photoreceptor 11a, a charger, an LD, a developing unit, and a transfer unit (not shown) which are provided around the photoreceptor 11a. In addition, the image forming unit 11 includes a fixing unit 15 which is provided in the transport path 13 on the downstream side of the photoreceptor 11a.

The transport path 13 extends on the downstream side of the fixing unit 15 and is connected to a transport path 23 of the relay apparatus body 20. A reverse transport path 16 which is branched on the downstream side of the fixing unit 15 and is coupled to the transport path 13 on the upstream side of the image forming unit 11 is connected to the transport path 13. A reverse unit 17 which reverses a sheet is provided in the reverse transport path 16. The sheet which is reversed by the reverse unit 17 can pass through the reverse transport path 16 and return to the transport path 13 on the upstream side of the image forming unit 11. In addition, the sheet which is reversed by the switching of the path may return to the transport path 13 on the downstream side of the fixing unit 15 and may be transported to the relay apparatus body 20 as it is.

In the image forming unit 11, the charger uniformly charges the surface of the photoreceptor 11a before an image is written and the LD irradiates the photoreceptor 11a having the uniformly-changed surface with a semiconductor laser to form an electrostatic latent image on the photoreceptor 11a. The developing unit develops the electrostatic latent image which is formed on the photoreceptor 11a by the LD with a toner member. A toner image is formed on the photoreceptor 11a by this development process. The transfer unit transfers the toner image on the photoreceptor 11a to the sheet transported from the paper feed tray 12. The sheet having the toner image transferred thereto is separated from the photoreceptor 11a and is then transported to the fixing unit 15. The toner member which remains on the photoreceptor 11a is removed by a cleaning unit (not shown).

The fixing unit 15 heats the transported sheet to fix the toner image transferred to the surface of the sheet as an output image. The sheet subjected to the fixing process is transported to the relay apparatus body 20 through the transport path 13, or it passes through the reverse transport path 16, is reversed by the reverse unit 17, and then returns to the transport path 13 on the upstream side of the image forming unit 11. An image can be formed, on the rear surface of the reversed sheet by the image forming unit 11.

The relay apparatus body 20 includes the transport path 23 which is connected to the transport path 13 and is connected to the post-processing apparatus body 30 in the subsequent stage. The transport path 23 includes a reverse and stack unit 21 which can reverse the sheet transported through the transport path 23 or can stack a predetermined number of sheets. The sheets which are stacked by the reverse and stack unit 21 can be transported to the post-processing apparatus body 30 at a predetermined time. In addition, the sheet can be transported to the post-processing apparatus body 30 through the transport path 23, without being stacked by the reverse and stack unit 21. Furthermore, the sheet may be reversed by the reverse and stack unit 21, without being stacked, and then transported to the rear side again. An in-line sensor 25 which detects an output image on the surface of the sheet transported through the transport path 23 on the upstream side of the reverse and stack unit 21 is provided in the transport path 23. The in-line sensor 25 can detect the output image with a length corresponding to the maximum width of the sheet. A sensor in which, for example, a CCD or a CMOS is arranged in a direction (for example, an orthogonal direction) intersecting the direction in which the sheet is transported can be used as the in-line sensor. The in-line sensor 25 corresponds to an image detection unit according to the embodiments. In addition, the in-line sensors 25 may be provided on the upper and lower sides of the transport path 23 to detect the output images on the front and rear surfaces of the transported sheet at the same time.

The post-processing apparatus body 30 performs predetermined post-processing, such as punching, folding, or saddle stitch stapling. The post-processing apparatus body 30 includes a post-processing unit (not shown) corresponding to the predetermined post-processing. The post-processing unit performs the predetermined post-processing for the sheet which is transported from the relay apparatus body 20, on the basis of the settings of the post-processing. When the execution of the post-processing is not set, it is possible to discharge the sheet to the sheet discharge unit 31, without performing the post-processing.

Next, the functional structure of the image forming apparatus 1 will be described with reference to FIG. 2.

The image forming apparatus body 10 includes a body controller 100, the scanner unit 130, the operation unit 140, a printer unit 150, and a print controller 160 which processes image data input from an external apparatus 2, such as a terminal PC, through a LAN 3 or can transmit image data obtained by the scanner unit 130 to the external apparatus 2 through the LAN 3.

The scanner unit 130 corresponds to a document reading unit according to the embodiments.

The body controller 100 includes a PCI bus 114 which is connected to the print controller 160 and a DRAM control IC 115 is connected to the PCI bus 114. An image memory (DRAM) 120 is connected to the DRAM control IC 115. The image memory (DRAM) 120 includes a compression memory 121 which stores compressed image data and a decompression memory 122 which temporarily stores decompressed image data, which is a print target, before an image is formed.

An HDD 123 (hard disk) is connected to the PCI bus 114. The HDD 123 can store the image data acquired by the scanner unit 130 or the image data generated by, for example, the external apparatus 2 connected to the print controller 160.

The image data acquired by the print controller 160 or the image data stored in the HDD 123 is transmitted to the DRAM control IC 115 through the PCI bus 114, with the execution of a printing operation.

The body controller 100 includes a control CPU 110. The DRAM control IC 115 is connected to the control CPU 110.

A program memory 111 which includes a and stores, for example, a program for operating the control CPU 110, a system memory 112 which includes a RAM and is used as, for example, a work area, and a non-volatile memory 113 which includes, for example, a flash memory, are connected to the control CPU 110. The non-volatile memory 113 stores, for example, the initial print setting information of the image forming apparatus body 10, apparatus setting information, such as process control parameters, initial data for output setting, an instruction to read the output image, and setting data related to sample discharge including, a sample discharge interval such that they can be read.

The control CPU 110 can read non-volatile data of the non-volatile memory 113 and write desired data to the non-volatile memory 113.

The control CPU 110 is operated by the program stored in the program memory 111 and controls the operation of each unit of the image forming apparatus 1 on the basis of, for example, the apparatus setting information, the print setting information, and the output settings.

The control CPU 110, the program memory 111, the system memory 112, and the non-volatile memory 113 constitute a controller according to the embodiments.

The control CPU 110 sets the output of a job, an operation instruction, and the sample discharge interval through the operation unit 140.

The scanner unit 130 includes a CCD 131 which performs optical reading and a scanner controller 132 which controls the overall operation of the scanner unit 130. The scanner controller 132 is connected to the control CPU 110 so as to perform serial communication therewith. The CCD 131 is connected to a reading processing unit 116 which processes image data read by the CCD 131 and the reading processing unit 116 is connected to the DRAM control IC 115 such that it can be controlled. The scanner unit 130 corresponds to a document reading unit according to the embodiments.

The reading processing unit 116 performs various kinds of processing, such as analog signal processing, an A/D (analog-to-digital) conversion process, and a shading process, for an analog image signal which is input from the CCD 131 to generate digital image data and outputs the digital image data to a compression/decompression IC 124.

The scanner unit 130 reads the image of a document which is placed on the upper platen glass of the image forming apparatus body 10 or a document which is automatically transported by the automatic document feeder (ADF) 14.

The operation unit 140 functions as both the display unit and the operation unit and includes the LCD 141 which has a touch panel and an operation unit controller 142 which controls the overall operation of the operation unit 140. The operation unit controller 142 is connected to the control CPU 110 so as to perform serial communication therewith.

In the operation unit 140, under the control of the control CPU 110, the LCD 141 enables the input of the mechanical settings of the image forming apparatus body 10, such as the setting of output conditions or the input of operation control conditions, the input of the sheet information (a size and a sheet type) settings of each paper feed tray, the display of the settings, the display of desired information, such as messages, the display of the image of the output image read by the in-line sensor 25, an operation instruction related to image display, the input of the settings of the operation, and the display of the settings of the operation.

The compression/decompression IC 124 which can compress or decompress image data is connected to the DRAM control IC 115. The DRAM control IC 115 controls an image data compression process and a compressed image data decompression process by the compression/decompression IC 124 and controls the input and output of image data to and from the image memory (DRAM) 120, in response to instructions from the control CPU 110.

A writing processing unit 125 is connected to the image forming unit 11 including, for example, an LD 152 of the printer unit 150 and generates write data used for the operation of the LD 152 on the basis of the image data.

The printer unit 150 includes, for example, the image forming unit 11, the paper feed trays 12, the transport path 13, the reverse transport path 16, and the fixing unit 15.

In addition, the printer unit 150 includes a printer controller 151 which controls the overall operation of the printer unit 150 (for example, a sheet feeding operation, an image forming operation, a sheet discharge operation, and post-processing). The printer controller 151 is connected to the control CPU 110 so as to perform serial communication therewith. The printer controller 151 operates in response to a control command from the control CPU 110 and controls the printer unit 150 to perform, for example, the transport of sheets and the formation of images.

A DRAM control IC 161 of the print controller 160 is connected to the PCI bus 114 to which the DRAM control IC 115 is connected, as described above. When the image forming apparatus body 10 is used as a network printer or a network scanner, the print controller 160 receives the image data from, for example, the external apparatus 2 connected to the LAN 3 in the image forming apparatus body 10 or transmits the image data acquired by the scanner unit 130 to the external apparatus 2, such as a terminal PC connected to the LAN 3.

In the print controller 160, an image memory 162 which includes a DRAM and the like is connected to the DRAM control IC 161. In the print controller 160, the DRAM control IC 161, a controller control CPU 163 which controls the overall operation of the print controller 160, and a LAN interface 165 are connected to a common bus. The LAN interface 165 is connected to the LAN 3.

An in-line sensor controller 25a of the in-line sensor 25 which is provided in the relay apparatus body 20 is connected to the control CPU 110 so as to be controlled. The control CPU 110 can control the operation of the in-line sensor 25 through the in-line sensor controller 25a. In addition, the control CPU 110 can receive the reading result of the in-line sensor 25.

An IO unit 118 is connected to the control CPU 110. The IO unit 118 operates as an interface which transmits and receives information to and from each unit of the image forming apparatus 1.

Next, the basic operation of the image forming apparatus 1 will be described.

First, a storage process for image data in the image forming apparatus body 10 will be described.

A case in which the scanner unit 130 reads an image and generates the image data in the image forming apparatus body 10 will be described. In the scanner unit 130, the CCD 131 optically reads images from a document. At that time, the scanner controller 132 receives instructions from the control CPU 110 and controls the operation of the CCD 131. The document may be read while being automatically fed by the automatic document feeder (ADF) 14. In addition, the document may be placed on the platen glass and then is read.

The control CPU 110 is operated by a program and issues a command to the scanner unit 130 on the basis of an operation (a reading instruction or a copy instruction) input through the operation unit 140. The reading processing unit 116 performs data processing for the image read by the CCD 131 and the processed image data is transmitted to the compression/decompression IC 124 through the DRAM control IC 115 and is then compressed by a predetermined method. The compressed data is stored in the image memory (DRAM) 120 through the DRAM control. IC 115. When data is stored in the HDD 123, the data which is temporarily stored in the compression memory 121 is transmitted to the HDD 123 through the DRAM control IC 115. Data for an image can be used as reference data or data which is used to determine whether to change the sample discharge interval.

Some other image data is input to the image forming apparatus body 10 through the LAN 3. Examples of the image data include data which is generated by an application program of the external apparatus 2. A method for generating the image data is not particularly limited.

The print controller 160 receives the image data through the LAN 3 and the LAN interlace 165. The DRAM control IC 161 temporarily stores print data which is expanded by the controller control CPU 163 in the image memory 162. The data stored in the image memory 162 is transmitted to the DRAM control IC 115 through the PCI bus 114 and is then temporarily stored in the decompression memory 122. The data stored in the decompression memory 122 is transmitted to the compression/decompression IC 124 through the DRAM control IC 115 and is then compressed. The compressed data is stored in the compression memory 121 through the DRAM control IC 115. When the data is stored in the HDD 123, the data which is temporarily stored in the compression memory 121 is transmitted to the HDD 123 through the DRAM control IC 115.

When the image data is accumulated, output setting is performed before or after the image data is accumulated. The output setting can be performed by displaying a setting screen to which an operation can be input on the operation unit 140 such that the operator can input an operation. In setting, an output setting item is selected. Even when the operator does not input settings, output setting is performed by the initial setting.

When the image forming apparatus 1 outputs an image, that is, when the image forming apparatus 1 is used as a copy machine or a printer, the image data stored in the compression memory 121 is transmitted to the compression/decompression IC 124 through the DRAM control IC 115 and is then decompressed. Then, the decompressed data is transmitted to the writing processing unit 125. The LD 152 writes the decompressed data to the photoreceptor 11a which is charged by the charger. When the image data stored in the HDD 123 is used, the image data stored in the HDD 123 is temporarily stored in the compression memory 121 through the DRAM control IC 115. The image data stored in the compression memory 121 is transmitted to the compression/decompression IC 124 through the DRAM control IC 115 and is then decompressed. And the decompressed data is transmitted to the writing processing unit 125, similarly to the above.

In the printer unit 150, the printer controller 151 controls each unit in response to commands from the control CPU 110. In the image forming unit 11, the developing unit (not shown) develops the latent image written to the photoreceptor 11a as a toner image. The transfer unit (not shown) transfers the toner image to the sheet which is supplied by the transport path 13 and the fixing unit 15 fixes the toner image. After the toner image is transferred to the sheet, the cleaning unit (not shown) removes the toner remaining on the photoreceptor 11a.

This embodiment has been described on the premise that a monochrome image is formed. However, the image forming apparatus body may include photoreceptors corresponding to each color (for example, cyan, magenta, yellow, and black).

The sheet having the image formed thereon is transported to the relay apparatus body 20 through the transport path 13, the sheet is reversed by the reverse unit 17 in the reverse transport path 16 and is then transported in the relay apparatus body 20 through the transport path 13, or it is transported to the reverse transport path 16 and is circulated to the transport path 13. An image is formed on the rear surface of the sheet which is circulated to the transport path 13 and is then fixed to the rear surface. Then, the sheet is transported to the relay apparatus body 20 through the transport path 13.

In the relay apparatus body 20, the in-line sensor 25 reads a portion of or the entire output image on the surface of the sheet which is transported through the transport path 23 and the read image data is transmitted to the control CPU 110. The output image is read on the basis of the content of the set instruction. The setting contents are stored in, for example, the non-volatile memory 113. The content of the instruction is initially set or it is set by the user. The image data of the output image can be stored in the image memory (DRAM) 120 or the HDD 123.

The sheet is stacked in the reverse and stack unit 21, it is transported to the post-processing apparatus body 30 through the transport path 23, or it is reversed and transported to the rear side, according to the settings. In the post-processing apparatus body 30, predetermined post-processing is performed for the sheet, or the sheet is transported, without being subjected to the post-processing, and is then discharged to the sheet discharge unit 31, according to the settings. In addition, the reverse and stack unit 21 may perform only a process of reversing the sheet and transport the sheet to the rear side and the in-line sensor 25 may read the output image formed on the rear surface of the sheet. In this case, the sheet is reversed for only a reading operation. After the output image is read, the sheet is transported to the front side and is then stacked in the reverse and stack unit 21, or it is transported to the post-processing apparatus body 30 through the transport path 23, without being stacked.

The structure in which the image detection unit is provided in the apparatus in the subsequent stage of the image forming apparatus body 10 has been described above. However, the image detection unit may be provided in the image forming apparatus body.

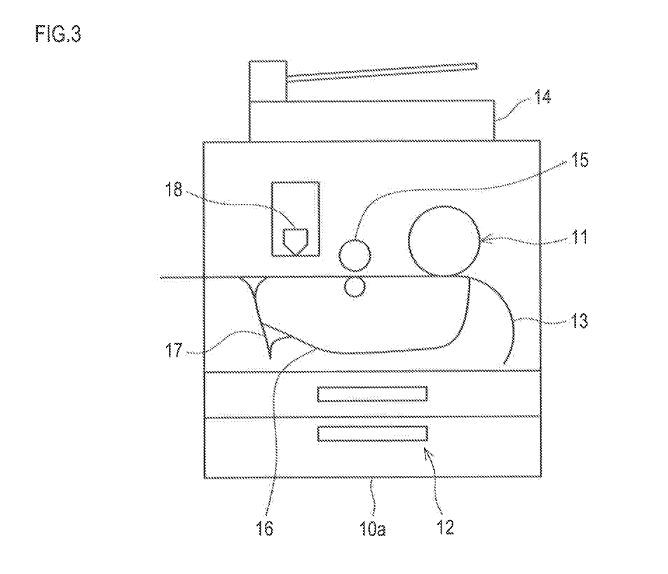

FIG. 3 illustrates a structure in which an in-line sensor 18 corresponding to the image detection unit is provided in an image forming apparatus body 10a. The in-line sensor 18 can have the same structure as the in-line sensor 25. The in-line sensor 18 also corresponds to the image detection unit according to the embodiments.

Another apparatus body may be further connected to the subsequent stage of the image forming apparatus body 10a. In addition, only the image forming apparatus body 10a may form the image forming apparatus. The same components as those in the above-described embodiment are denoted by the same reference numerals, and the description thereof will not be repeated or it will be described briefly.

In this embodiment, the in-line sensor 18 is arranged in a portion of the transport path 13 which is on the downstream side of the fixing unit 15 and is on the upstream side of a point where the reverse transport path 16 is branched from the transport path 13.

In this embodiment, when images are formed on the front and rear surfaces of the sheet, it is not necessary to reverse the sheet only in order to read the output images on the front and rear surfaces and the in-line sensor 18 can read the output images on the front and rear surfaces of the sheet.

That is, the sheet which passes through the fixing unit 15 is introduced to the reverse transport path 16 and the reverse unit 17 reverses the front and rear surfaces of the sheet. Then, the sheet returns to the transport path 13 and an image is formed on the rear surface of the sheet. The in-line sensor 18 can read the image on the downstream side of the fixing unit 15. Then, the reading result of the in-line sensor 18 is transmitted to the control CPU 110.

In this embodiment, reading can be performed before the sheet which has passed through the fixing unit 15 reaches the reverse transport path 16. Therefore, it is not necessary to reverse the sheet in order to only read both surfaces of the sheet with the in-line sensor.

The control CPU 110 can implement the sample discharge function and discharges a sample sheet at the sample discharge interval during a job. The sample discharge interval can be stored as initial settings in the non-volatile memory 113. In addition, the operator may use the operation unit 140 to initially set the sample discharge interval or change the settings of the sample discharge interval.

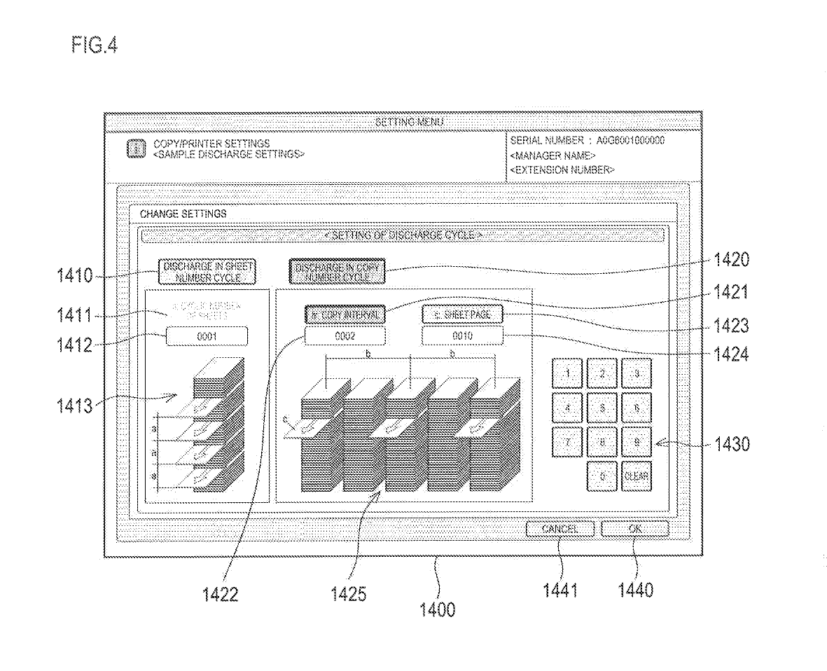

FIG. 4 illustrates a sample discharge interval setting screen 1400 which is displayed so as to be operated in the operation unit 140.

A “discharge in a sheet number cycle” button 1410 and a “discharge in a copy number cycle” button 1420 are horizontally displayed as setting items on the sample discharge interval setting screen 1400 such that they can be pressed. In this way, it is possible to switch the discharge setting of the sample discharge between discharge in a sheet number cycle and discharge in a copy number cycle.

For the setting item of “discharge in a sheet number cycle”, an “a: cyclic sheet number” display portion 1411 is displayed below the “discharge in a sheet number cycle” button 1410 and a cyclic sheet number input field 1412 is provided below the “a: cyclic sheet number” display portion 1411 such that a value can be input to the cyclic sheet number input field 1412. An image screen 1413 indicating sample discharge in a sheet number cycle is displayed below the cyclic sheet number input field 1412.

For the setting item of “discharge in a copy number cycle”, a “b: copy interval” button 1421 and a “c: sheet page” button 1423 are displayed below the “discharge in a copy number cycle” button 1420 so as to be horizontally arranged. A cyclic copy number input field 1422 is provided below the “b: copy interval” button 1421 such that a value can be input to the cyclic copy number input field 1422. In addition, a sheet page input field 1424 is provided below the “c: sheet page” button 1423 such that a value can be input to the sheet page input field 1424. An image screen 1425 indicating sample discharge in a copy number cycle is displayed below the cyclic copy number input field 1422 and the sheet page input field 1424.

In addition, a numerical keypad 1430 is displayed on the right side of the setting item of “discharge in a copy number cycle” so as to be operated and an “OK” button 1440 and a cancel button 1441 are displayed below the numerical keypad 1430 such that they can be pressed.

In the sample discharge interval setting screen 1400, when the “discharge in a sheet number cycle” is set, the “a: cyclic sheet number” display portion 1411 is highlighted and the numeric keypad 1430 can be used to input the cyclic sheet number to the cyclic sheet number input field 1412. At that time, the “b: copy interval” button 1421 and the “c: sheet page” button 1423 are shaded and setting using the buttons is unavailable. In the settings on this screen, sample discharge is performed for each sheet. After a value is input to the cyclic sheet number input field 1412, the “OK” button 1440 is pressed to confirm the settings and the “cancel” button 1441 is pressed to cancel the settings.

When the “discharge in a copy number cycle” is set, the “a: cyclic sheet number” display portion 1411 is shaded and the input of a value to the cyclic sheet number input field 1412 is unavailable. At the beginning of the setting of the “discharge in a copy number cycle”, the “b: copy interval” button 1421 is selected and highlighted. The operation of the “c: sheet page” button 1423 is available and the button can be pressed to switch an input. The value input by the numeric keypad 1430 is input to the set value of the selection state of the copy interval or the sheet page. In the settings on this screen, a tenth sheet is discharged as a sample for every two copies. When values are input to the cyclic copy number input field 1422 and the sheet page input field 1424, the “OK” button 1440 is pressed to confirm the settings and the “cancel” button 1441 is pressed to cancel the settings.

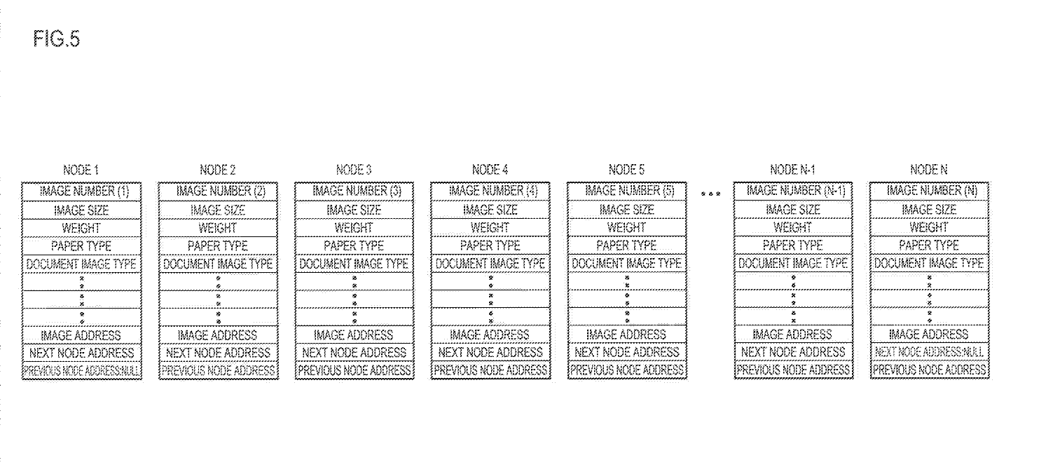

In this embodiment, the sample discharge interval can be changed depending on whether the image is a photograph or a character, which will be described below. FIG. 5 is a diagram illustrating the image of an image list and each node includes items, such as a sheet size, a weight, a paper type, and a document image type. Information indicating a character image or a photograph image is stored in the document image type. The control CPU 110 can change the sample discharge interval considering the document image type.

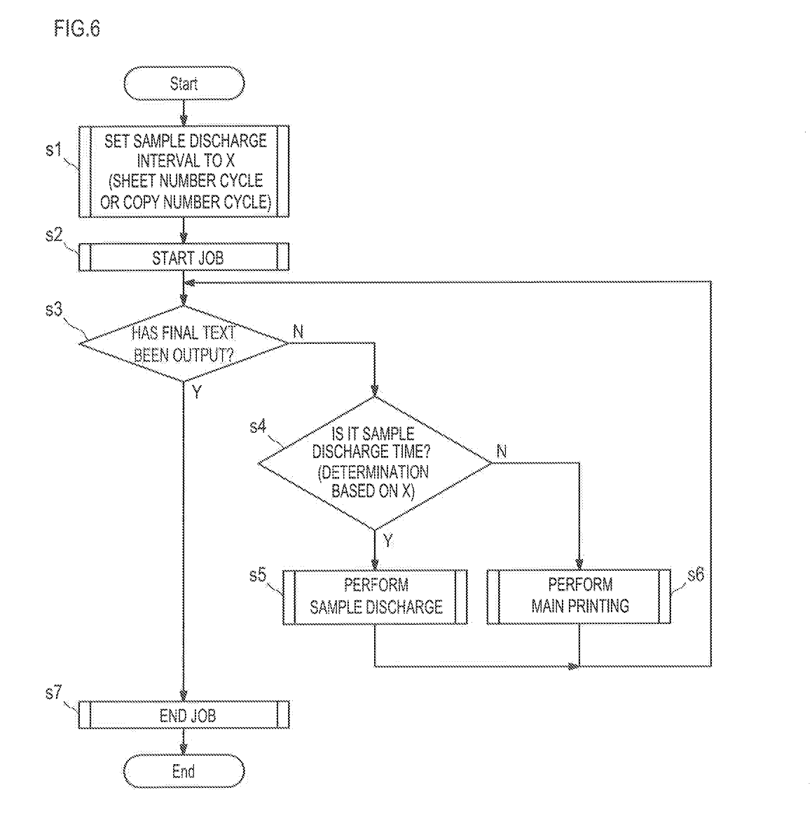

FIG. 6 is a flowchart illustrating a sample discharge process while a job is being performed and the sample discharge process will be described below. A change in the sample discharge interval can be set so as to be available or unavailable. When the change in the sample discharge interval is set to be unavailable, sample discharge is performed as follows.

First, the sample discharge interval is set and stored in a condition X (Step s1). The settings of the sample discharge interval can be acquired by reading the setting data stored in, for example, the non-volatile, memory 113. In addition, the sample discharge interval can be set through the operation unit 140. The sample discharge interval can be set under appropriate conditions, such as a sheet number cycle, a copy number cycle, or a time period. This embodiment is not limited to specific conditions.

A job is started by, for example, the reading of a document image, the acquisition of image data from the outside, or the execution of a stored job (Step s2) and it is determined whether the final main body has been output (Step s3). When the final main body has been output (Y in Step s3), the job ends (Step s7). When the final main body has not been output (N in Step s3), it is determined that it is a sample discharge time on the basis of the conditions X (Step s4). When it is determined that it is the sample discharge time (Y in Step s4), sample discharge is performed (Step s5) and the process proceeds to Step s3 which determines whether the final main body has been output. When it is determined that it is not the sample discharge time (N in Step s4), main body printing is performed (Step s6) and the process proceeds to Step s3 which determines whether the final body has been output.

Sample discharge is performed at the time set by the above-mentioned process.

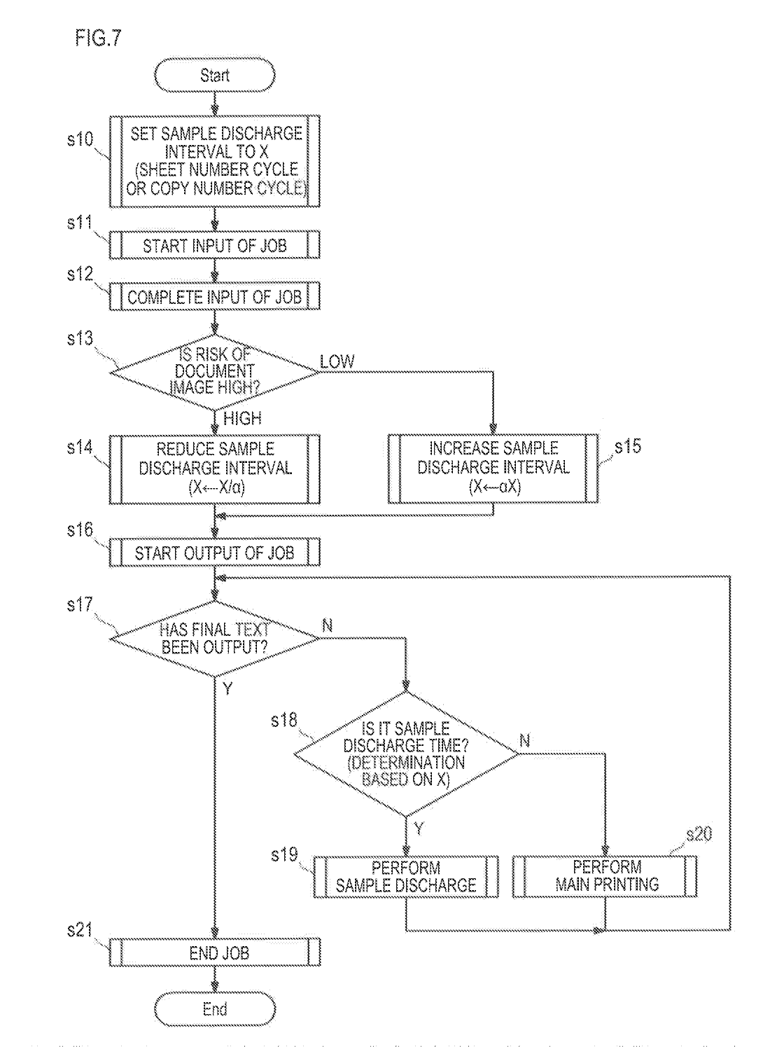

Next, a process of changing the set sample discharge interval on the basis of information about a document image will be described with reference to the flowchart illustrated in FIG. 7. The following process is controlled by the control CPU 110.

First, the settings of the sample discharge interval, which include the sheet number cycle or the copy number cycle, are stored in the condition X (Step s10). The settings of the sample discharge interval can be acquired by reading the setting data stored in, for example, the non-volatile memory 113. In addition, the sample discharge interval can be set through the operation unit 140.

The input of a job is started by, for example, the reading of a document image or the acquisition of image data from the outside (Step s11) and the input of the job is completed (Step s12). The document image is stored in the image memory (DRAM) 120. Then, it is determined whether the document image has a high risk. (Step s13). An example of the determination of the risk of the document image is described in the following Table 1.

As determination elements, an image type, an image type (the number of pages), and coverage are shown. In the determination based on the image type, only a text page is determined to have a low risk and a photograph page is determined to have a high risk. In the determination based on the image type (the number of pages), the risk of the document image is determined on the basis of the comparison between the number of text pages and the number of photograph pages.

That is, when the number of text pages is more than the number of photograph pages, the risk is low. When the number of text pages is equal to or less than the number of photograph pages, the risk is high. In this example, half of the total number of pages is a first predetermined number of pages and a second predetermined number of pages in the embodiments. However, the first predetermined number of pages and the second predetermined number of pages can be set in the range of that the first predetermined number of pages is equal to or more than the second predetermined number of pages. In this case, when the number of photograph pages is equal to or more than the first predetermined number of pages, the risk is determined to be high. When the number of photograph pages is less than the second predetermined number of pages, the risk is determined to be low.

In the determination process, it is possible to determine the risk on the basis of coverage.

For example, when the coverage is low and a color printing machine (color printing) is used, the risk is determined to be low. When the coverage is low and a black-and-white printing machine (monochrome printing) is used, the risk is determined to be high. When the coverage is high and a color printing machine (color printing) is used, the risk is determined to be high. When the coverage is high and a black-and-white printing machine (monochrome printing) is used, the risk is determined to be low. It is possible to determine whether the coverage is low or high on the basis of a predetermined value and different predetermined values is first predetermined monochrome coverage value, a second predetermined monochrome coverage value, a first predetermined color coverage value, and a second predetermined color coverage value) can be defined.

TABLE 1
Example of determination process

| Determination element | | Determination result |
|---|---|---|
| Image type | Only text page | Risk is low |
| | Photograph page is present | Risk is high |
| Image type | Number of text pages > | Risk is low |
| (number of | number of photograph | |
| pages) | pages | |
| | Number of text pages ≦ | Risk is high |
| | number of photograph | |
| | pages | |
| Coverage | Low coverage | Risk is low in color |
| | | printing machine, and risk |
| | | is high in black-and-white |
| | | printing machine |
| | High coverage | Risk is low in black-and- |
| | | white printing machine, |
| | | and risk is high in color |
| | | printing machine |

When it is determined that the risk of the document image is high on the basis of the content of the determination process (high in Step s13), the sample discharge interval is changed to a smaller value (Step s14). When it is determined that the risk of the document image is low (Step s13, low), the sample discharge interval is changed to a larger value (Step s15).

For example, when the sample discharge interval is changed to a smaller value, X/α (α>1) is replaced with X. For example, when the sample discharge interval is changed to a larger value, α×X (α>1) is replaced with X. A different value may be set to a coefficient α when the sample discharge interval is reduced and when the sample discharge interval is increased. In addition, the value may vary depending on the content of the determination process. The coefficient may he stored in, for example, the non-volatile memory 113 such that it can be read. When the sample discharge interval is changed, it is not calculated using the coefficient, but the detailed sheet discharge interval which is set in, for example, the non-volatile memory may be used.

In this example, the sample discharge interval is reduced or, increased on the basis of whether the risk is high or low. However, the sample discharge interval can be changed only when the risk is high or only when the risk is low.

After the sample discharge interval is changed, the output of the job starts (Step s16). In this example, it is determined whether the risk is high or low and the sample discharge interval is certainly changed on the basis of the determination result. However, the output of the job may start, without changing the sample discharge interval, depending on the level of the risk.

After the output of the job starts, it is determined whether the final main body has been output (Step s17). When the final main body has been output (Y in Step s17), the job ends (Step s21). When the final main body has not been output (N in Step s17), it is determined whether it is the sample discharge time on the basis of the condition X (Step s18). During the determination process, the number of sheets fed and the number of sheets fed copies are counted and the count values are compared with the sample discharge interval settings X to determine whether it is the sample discharge time. It is preferable that the sample discharge time be determined before a sheet is fed.

When it is determined that it is the sample discharge time (Y in Step s18), sample discharge is performed (Step s19) and the process proceeds to Step s17 which determines whether the final main body has been output. When it is determined that it is not the sample discharge time (N in Step s18), main body printing is performed (Step s20) and the process proceeds to Step s17 which determines whether the final main body has been output.

Sample discharge is performed at the time which is changed on the basis of information about the document image by the above-mentioned process.

In the above-mentioned process, after the input of the job is completed (after the reading of all pages is completed), it is determined whether the risk of the document image is high or low, it is determined whether to change the sample discharge interval, and the change is applied. However, when a job output starts while a job is being input, a change in the sample discharge interval can be applied from the second copy.

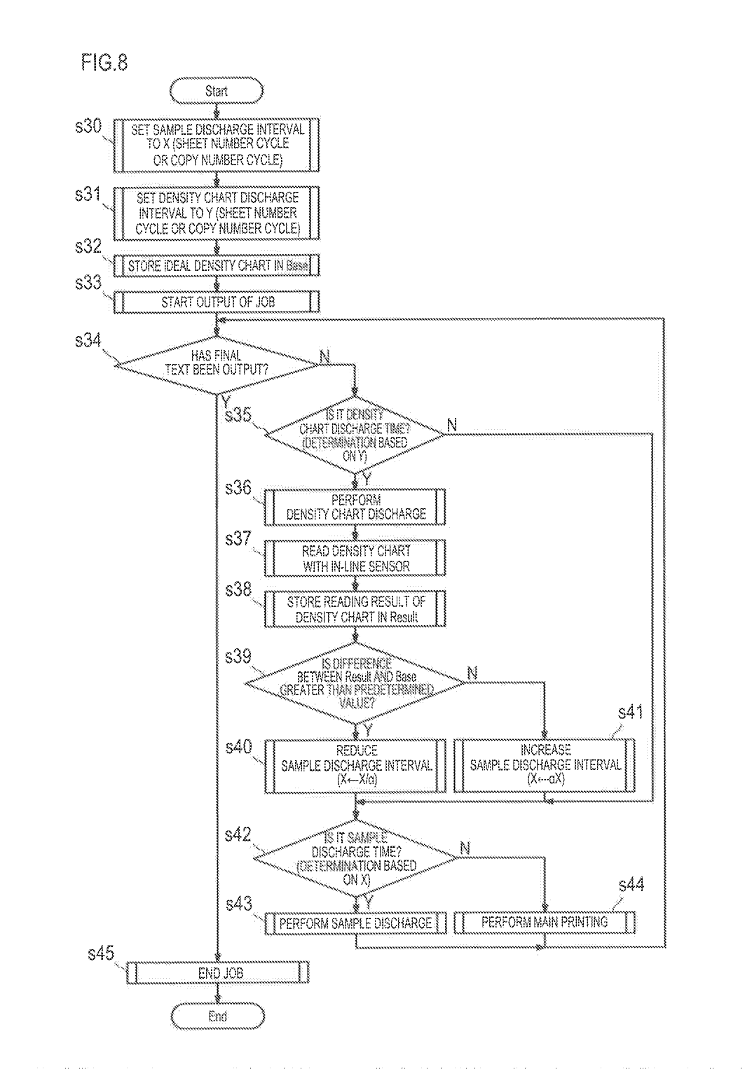

Next, a process of determining whether to change the sample discharge interval on the basis of the output image read by the in-line sensor 25 will be described with reference to the flowchart described in FIG. 8. In this example, the determination is performed using the periodic output result of a density chart. The following process is controlled by the control CPU 110.

First, the settings of the sample discharge interval, which is the sheet number cycle or the copy number cycle, are stored in the condition X (Step s30). The settings of the sample discharge interval can be acquired by reading the setting data which is stored in, for example, the non-volatile memory 113. In addition, the sample discharge interval can be set through the operation unit 140.

Then, the settings of the sheet discharge interval using the density chart are stored in a condition Y (Step s31). A density chart discharge interval can be acquired by reading the setting data stored in, for example, the non-volatile memory 113.

Then, the settings of an ideal density chart which has been set in advance are stored in variable. Base (Step s32). The ideal density chart can be acquired by reading the setting data stored in, for example, the non-volatile memory 113.

Then, the output of a job is started by, for example, the reading of a document image or the acquisition of image data from the outside (Step s33) and it is determined whether the final main body has been output (Step s34). When the final main body has been output (Y in Step s34), the job ends (Step s45). When the final main body has not been output (N in Step s34), it is determined Whether it is the density chart discharge time on the basis of the condition Y (Step s35). When it is determined that it is not the density chart discharge time (N in Step s35), the process proceeds to a step of determining whether it is the sample discharge time (Step s42).

When it is determined that it is the density chart discharge time (Y in Step s35), the density chart is output to a sheet and the sheet is discharged to the outside of the image forming apparatus body (Step s36). When the in-line, sensor is provided in the image forming apparatus body, the sheet is transported in the apparatus.

The in-line sensor reads the sheet having the density chart printed thereon (Step s37) and the reading result of the density chart is stored in a variable Result (Step s38). Then, Result is compared with Base and it is determined whether the difference therebetween is greater than a predetermined value (Step s39). The predetermined value is prepared for determining the density chart and is stored in, for example, the non-volatile memory 113 such that it can be read. When the difference between Result and Base is greater than the predetermined value (Y in Step s39), the sample discharge interval is changed to a smaller value (Step s40). When the difference between Result and Base is not greater than the predetermined value (in Step s39), the sample discharge interval is changed to a larger value (Step s41).

For example, when the sample discharge interval is changed to a smaller value, X/α (α>1) is replaced with X. For example, when the sample discharge interval is changed to a larger value, α×X (α>1) is replaced with X. A different value may be set to a coefficient α when the sample discharge interval is reduced and when the sample discharge interval is increased. In addition, the value may vary depending on the content of the determination process. The coefficient may be stored in, for example, the non-volatile memory such that it can be read. When the sample discharge interval is changed, it is not calculated using the coefficient, but the detailed sheet discharge interval which is set in, for example, the non-volatile memory 113 may be used. In this example, the sample discharge interval is reduced or increased on the basis of whether the difference in the density chart is large or small. However, the sample discharge interval may be changed only when the difference in the density chart is large or only when the difference in the density chart is small.

Then, it is determined whether it is the sample discharge time on the basis of the sample discharge interval X (Step s42). When it is determined that it is the sample discharge time (Y in Step s42), sample discharge is performed (Step s43) and the process proceeds to Step s34 which determines whether the final main body has been output. When it is determined that it is not the sample discharge time (N in Step s42), main body printing is performed (Step s44) and the process proceeds to Step s34 which determines whether the final main body has been output.

The sample discharge is performed by the above-mentioned process at the time which is changed on the basis of a change in the density chart. In the above-mentioned example, it is determined whether to change the sample discharge interval on the basis of the change in the density, chart with respect to the reference. However, the determination may be performed on the basis of a change in the density chart between different sheets.

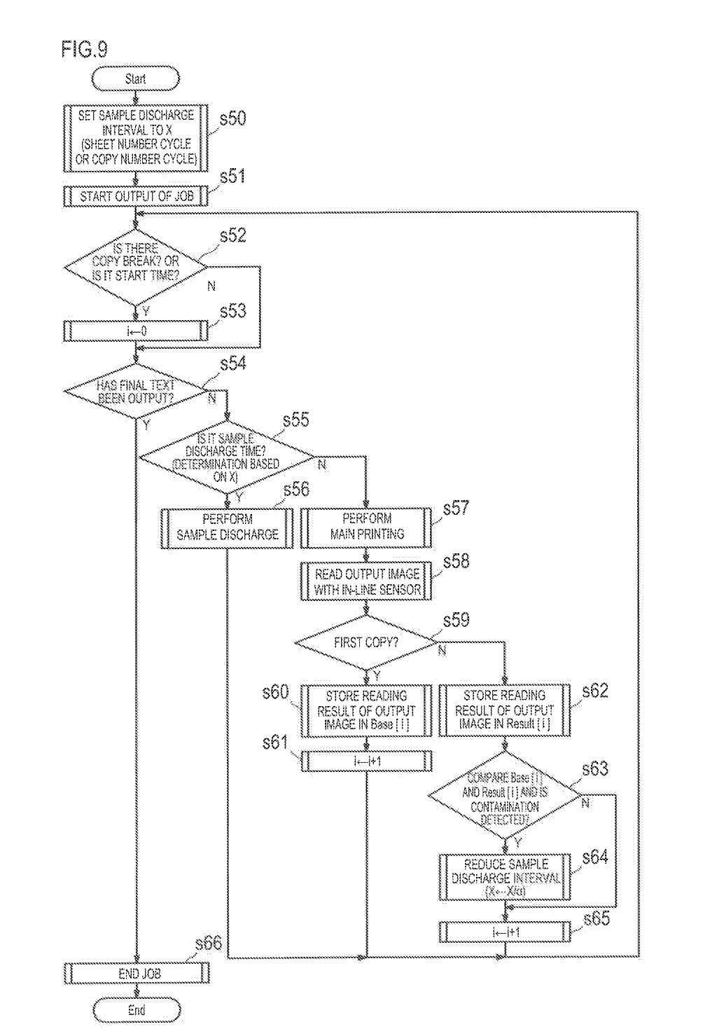

Next, a process of determining whether to change the sample discharge interval on the basis of the output image related to a job which is read by the in-line sensor 25 will be described with reference to the flowchart described in FIG. 9. In this example, the determination is performed using the density chart. The following process is controlled by the control CPU 110.

First, the settings of the sample discharge interval, which is a sheet number cycle or a copy number cycle, are stored in the condition X (Step s50). The settings of the sample discharge interval can be acquired by reading the setting data stored in, for example, the non-volatile memory 113. In addition, the sample discharge interval can be set through the operation unit 140.

Then, the output of the job is started by, for example, the reading of the document image or the acquisition of image data from the outside (Step s51) and it is determined whether there is a copy break or whether it is the start time (Step s52). When it is determined that there is a copy break or it is the start time (Y in Step s52), 0 is substituted into a variable i and the process proceeds to Step s54. In the other cases, Step s53 is skipped and the process proceeds to Step s54.

In Step s54, it is determined whether the final main body has been output (Step s54). When the final main body has been output (Y in Step s54), the job ends (Step s66). When the final main body has not been output (N in Step s54), it is determined whether it is the sample discharge time on the basis of the condition X (Step s55). When it is determined that it is the sample discharge time (Y in Step s55), sample discharge is performed (Step s56) and the process proceeds to Step s52 which determines whether there is a copy break or whether it is the start time.

When it is determined that it is not the sample discharge time (N in Step s55), main body printing is performed (Step s57). The in-line sensor reads the sheet having the output image printed thereon (Step s58). It is determined whether the copy is a first copy (Step s59).

When the copy is the first copy (Y in Step s59), the reading result of the output image is stored in Base(i) which is a reference image (Step s60) and 1 is added to the variable i (Step s61). Then, the process proceeds to Step s52 which determines whether there is a copy break or whether it is the start time.

When the sheet is not the first copy (N in Step s59), the reading result of the output image is stored in Result(i) (Step s62). Then, Base(i) is compared with Result(i) and it is detected whether there is a contamination from the comparison result (Step s63). For example, when a predetermined number of pixels which are present in Result(i), but are absent in Base(i) are detected, it can be determined that there is a contamination.

When a contamination is detected (Y in Step s63), the sample discharge interval is changed to a smaller value (Step s64). For example, X/α (α>1) is replaced with X. In addition, when the sample discharge interval is changed, it is not calculated using the coefficient, but the detailed sheet discharge interval which is set in, for example, the non-volatile memory may be used.

After Step s64 or when it is determined that no contamination is detected (N in Step s63), 1 is added to the variable i (Step s65) and the process proceeds to Step s52 which determines whether there is a copy break or whether it is the start time.

According to the above, it is possible to change the sample discharge interval, on the basis of the detection of a contamination on the output sheet.

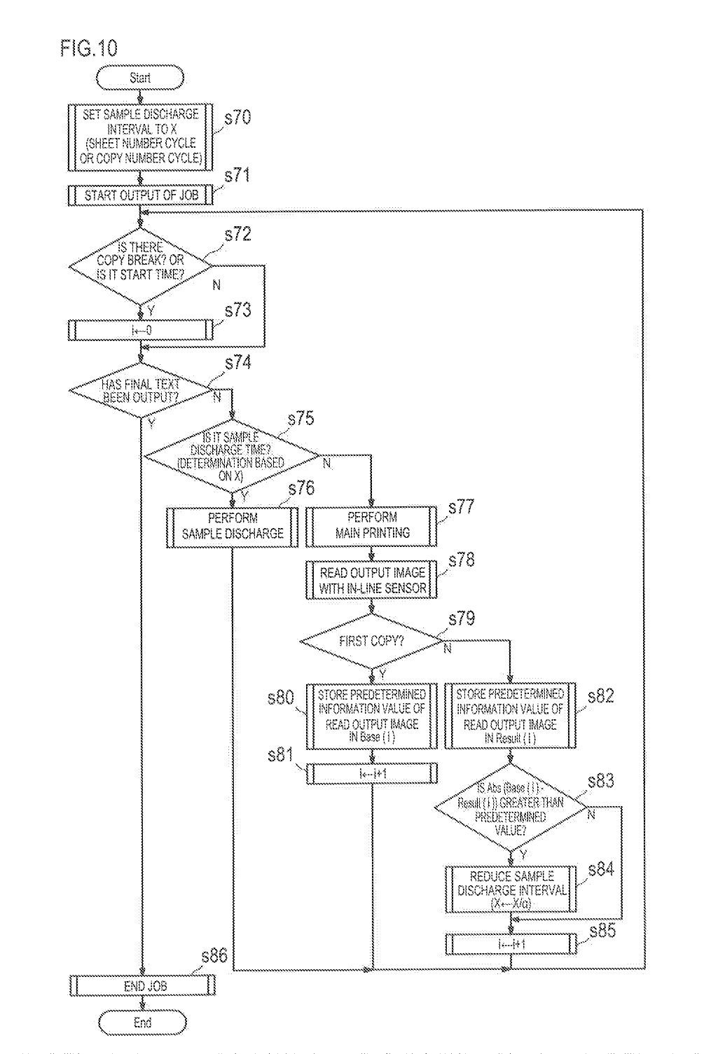

Next, a process of determining whether to change the sample discharge interval on the basis of information about the output image related to a job which is read by the in-line sensor 25 will be described with reference to the flowchart described in FIG. 10. In this example, the output image is compared with reference data for each page and determination is performed on the basis of the comparison result. The following process is controlled by the control CPU 110.

First, the settings of the sample discharge interval, which is a sheet number cycle or a copy number cycle, are stored in the condition X (Step s70). The settings of the sample discharge interval can be acquired by reading the setting data stored in, for example, the non-volatile memory 113. In addition, the sample discharge interval can be set through the operation unit 140.

Then, the output of the job is started by, for example, the reading of the document image or the acquisition of image data from the outside (Step s71) and it is determined whether there is a copy break or whether it is the start time (Step s72). When it is determined that there is a copy break or it is the start time (Y in Step s72), 0 is substituted into the variable i and the process proceeds to Step s74. In the other cases, Step s73 is skipped and the process proceeds to Step s74.

In Step s74, it is determined whether the final main body has been output (Step s74). When the final main body has been output (Y in Step s74), the job ends (Step s86). When the final main body has not been output (N in Step s74), it is determined whether it is the sample discharge time on the basis of the condition X (Step s75). When it is determined that it is the sample discharge time (Y in Step s75), sample discharge is performed (Step s76) and the process proceeds to Step s72 which determines whether there is a copy break or whether it is the start time.

When it is determined that it is not the sample discharge time (N in Step s75), main body printing is performed (Step s77). The in-line sensor reads the sheet having the output image printed thereon (Step s78). It is determined whether the copy is a first copy (Step s79).

When the copy is the first copy (Y in Step s79), a predetermined information value of the read output image is stored in Base(i), which is a reference image (Step s80), and 1 is added to the variable i (Step s81). Then, the process proceeds to Step s72 which determines whether there is a copy break or whether it is the start time. When the copy is not the first copy (N in Step s79), the predetermined information value of the read output image is stored in Result(i) (Step s82). Then, Base(i) is compared with Result(i) and it is determined whether a difference between Base(i) and Result(i) is greater than a predetermined value (Step s83). For example, the amount of attached toner, density, or the position of a register mark of each page can be used as the predetermined information value. When a difference in the predetermined information value is greater than a predetermined value (Y in Step s83), the sample discharge interval is changed to a smaller value (Step s84). For example, X/α (α>1) is replaced with X. In addition, when the sample discharge interval is changed, it is not calculated using the coefficient, but the detailed sheet discharge interval which is set in, for example, the non-volatile memory may be used.

After Step s84 or when it is determined that the difference is equal to or less than the predetermined value (N in Step s83), 1 is added to the variable i (Step s85) and the process proceeds to Step s72 which determines whether there is a copy break or whether it is the start time.

According to the above-mentioned process, it is possible to compare the predetermined information value of the reference image and the predetermined information value of the output image for each page as a unit of comparison, and determine whether to change the sample discharge interval on the basis of the comparison result.

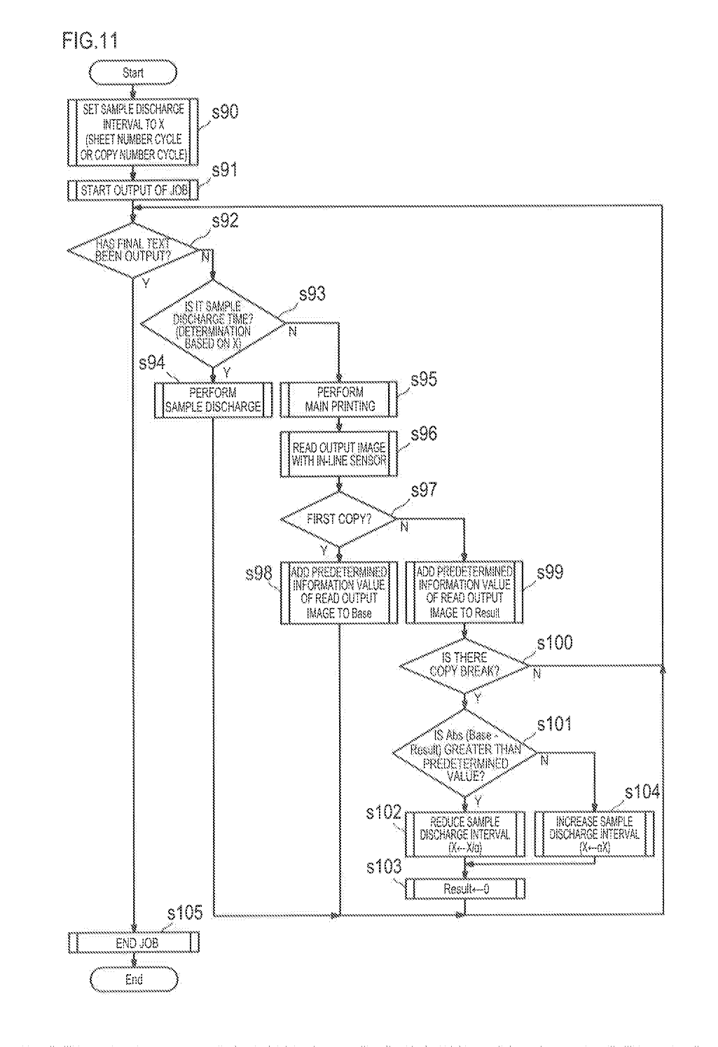

Next, a process of determining whether to change the sample discharge interval on the basis of information about the output image related to the job which is read by the in-line sensor 25 will be described with reference to the flowchart described in FIG. 11. In this example, the output image is compared with reference data for each copy. The following process is controlled by the control CPU 110.

First, the settings of the sample discharge interval, which is a sheet number cycle or a copy number cycle, are stored in the condition X (Step s90). The settings of the sample discharge interval can be acquired by reading the setting data stored in, for example, the non-volatile memory 113. In addition, the sample discharge interval can be set through the operation unit 140. Then, the output of the job is started by, for example, the reading of the document image or the acquisition of image data from the outside (Step s91) and it is determined whether the final main body has been output (Step s92). When the final main body has been output (Y in Step s92), the job ends (Step s105). When the final main body has not been output (N in Step s92), it is determined whether it is the sample discharge time on the basis of the condition X (Step s93).

When it is determined that it is the sample discharge time (Y in Step s93), sample discharge is performed (Step s94) and the process proceeds to Step s92 which determines whether the final main body has been output. When it is determined that it is not the sample discharge time (N in Step s93), main body printing is performed (Step s95). The in-line sensor reads the sheet having the output image printed thereon (Step s96). It is determined whether the copy is a first copy (Step s97).

When the copy is the first copy (Y in Step s97), a predetermined information value of the read output image is added to variable Base (Step s98) and the process proceeds to Step s92 which determines Whether the final main body has been output. When the copy is not the first copy (N in Step s97), the predetermined information value of the read output image is added to Result (Step s99). Then, it is determined whether there is a copy break (Step s100). When it is determined that there is no copy break (N in Step s100), the process proceeds to Step s92 which determines whether the final main body has been output.

When it is determined that there is a copy break (Y in Step s100), it is determined whether the absolute value of the difference between Base and Result is greater than a predetermined value (Step s101). When the absolute value of the difference is greater than the predetermined value (Y in Step s101), the sample discharge interval is changed to a smaller value (Step s102). When the absolute value of the difference is not greater than the predetermined value (N in Step s101), the sample discharge interval is changed to a larger value (Step s104). For example, the amount of attached toner or density of each page and each copy can be used as the predetermined information value.

For example, when the sample discharge interval is changed to a smaller value, X/α (α>1) is replaced with X. For example, when the sample discharge interval is changed to a larger value, α×X (α>1) is replaced with X. A different value may be set to a coefficient α when the sample discharge interval is reduced and when the sample discharge interval is increased. In addition, the value may vary depending on the content of the determination process. The coefficient may be stored in, for example, the non-volatile memory 113 such that it can be read. When the sample discharge interval is changed, it is not calculated using the coefficient, but the detailed sheet discharge interval which is set in, for example, the non-volatile memory may be used. In this example, the sample discharge interval is reduced or increased on the basis of whether the difference is large or small. However, the sample discharge interval may be changed only when the difference is greater than the predetermined value or only when the difference is equal to or less than the predetermined value.

According to the above-mentioned process, it is possible to compare the predetermined information value of the reference image with the predetermined information value of the output image for each copy, which is the unit of comparison, and determine whether to change the sample discharge interval on the basis of the comparison result.

In the processes described in FIGS. 10 and 11, the unit of comparison is a page or a copy. However, the embodiments is not limited thereto. For example, the unit of comparison may be a plurality of pages or a plurality of copies. In the embodiments, the unit of comparison is not particularly limited.

In the processes of the flowcharts described in FIGS. 10 and 11, the first copy is a reference. However, a proof output as a reference may be compared with the main output and may determine whether to change the sample discharge interval on the basis of the comparison result.

In the process in each of the above-described embodiments, it is determined whether to change the sample discharge interval on the basis of each determination element. However, the operation unit may be used to set whether to change the sample discharge interval (valid/invalid). The settings may be stored in for example, the non-volatile memory such that the settings as to whether the change determination process is available or unavailable can be checked in each of the above-mentioned processes.

As described above, according to the embodiments, it is determined whether to change the sample discharge interval on the basis of the information related to the image. Therefore, it is possible to set the sample discharge interval considering the state of the actual image. It is possible to perform sample discharge at an accurate time and stabilize image quality. In particular, the embodiments are effective when the quality of an output image is checked while a job is being executed in a machine which runs for a long time, for example, a production printing (PP) machine. In a PP workflow using sample discharge, it is possible to improve the accuracy of checking quality using the sample discharge, while reducing costs related to the sample discharge.

The invention has been described above on the basis of the embodiment. However, various modifications and changes of the invention can be made without departing from the scope and spirit of the invention.

What is claimed is:

1. An image forming apparatus comprising:
an image forming unit that forms an image on a sheet on the basis of a job; and
a controller that manages the job and controls the formation of the image,
wherein the controller enables a sample discharge and determines whether to change a sample discharge interval which is set in the sample discharge on the basis of information related to the image when the job is executed.

2. The image forming apparatus according to claim 1, further comprising:
a document reading unit that reads a document image,
wherein the information related to the image is related to the image read by the document reading unit.

3. The image forming apparatus according to claim 2,
wherein the controller determines whether to change the sample discharge interval, using a change in predetermined information of the image in a predetermined unit of comparison as the information related to the image.

4. The image forming apparatus according to claim 2,
wherein, in a case where the job is set such that a plurality of copies of the image read by the document reading unit are output, when the output starts after the reading of the entire document is completed, the controller applies a change in the sample discharge interval to a first copy, and when the job is set such that the output starts while the document is being read, the controller applies the change in the sample discharge interval to a second copy.

5. The image forming apparatus according to claim 1, further comprising:
an image detection unit that reads an output image of the sheet having the image formed thereon,
wherein the information related to the image is related to the image read by the image detection unit.

6. The image forming apparatus according to claim 5,
wherein the controller determines whether to change the sample discharge interval, using a change in predetermined information of the image in a predetermined unit of comparison as the information related to the image.

7. The image forming apparatus according to claim 5,
wherein, when the job is to output a plurality of copies, the controller uses the image read by the image detection unit as a reference image in a first copy, and in a second copy or subsequent copies, the controller compares the image read by the image detection unit with predetermined information of the reference image in a predetermined unit of comparison, and determines whether to change the sample discharge interval using the comparison result as the information related to the image.

8. The image forming apparatus according to claim 5,
wherein the controller has a proof discharge function, uses the image read by the image detection unit as a reference image in the proof discharge of the job, compares the image read by the image detection unit with predetermined information of the reference image in a predetermined unit of comparison, in the main output of the job, and determines whether to change the sample discharge interval using the comparison result as the information related to the image.

9. The image forming apparatus according to claim 5,
wherein the controller prints a density chart on a sheet when the job is executed, the image detection unit reads the density chart, and the controller determines whether to change the sample discharge interval using a density change in the density chart as the information related to the image.

10. The image forming apparatus according to claim 9,
wherein the controller determines to change the sample discharge interval to a smaller value when the density change is equal to or greater than a first predetermined value and determines to change the sample discharge interval to a larger value when the density change is less than a second predetermined value (where the first predetermined value is equal to or greater than the second predetermined value).

11. The image forming apparatus according to claim 5,
wherein the controller determines whether there is a contamination in the image read by the image detection unit, and when it is determined that there is a contamination, the controller determines to change the sample discharge interval to a smaller value.

12. The image forming apparatus according to claim 3,
wherein the unit of comparison is a page or a copy.

13. The image forming apparatus according to claim 3,
wherein the predetermined information is at least one of an amount of attached toner, density, and the position of a register mark of each page.

14. The image forming apparatus according to claim 1,
wherein the controller compares the number of text pages with the number of photograph pages in the image included in the job, the controller determines to change the sample discharge interval to a smaller value when the number of photograph pages is equal to or more than a first predetermined number of pages, and the controller determines to change the sample discharge interval to a larger value when the number of photograph pages is less than a second predetermined number of pages (where the first predetermined number of pages is equal to or more than the second predetermined number of pages).

15. The image forming apparatus according to claim 1,
wherein the controller determines whether to change the sample discharge interval using coverage of the job as the information related to the image.

16. The image forming apparatus according to claim 15,
wherein, in a case where the job is related to a monochrome image, when it is determined that the coverage of the image included in the job is low and is equal to or less than a first predetermined monochrome coverage value, the controller determines to change the sample discharge interval to a smaller value, and when it is determined that the coverage is high and is greater than a second predetermined monochrome coverage value (where the first predetermined monochrome coverage value is equal to or less than the second predetermined monochrome coverage value), the controller determines to change the sample discharge interval to a larger value.

17. The image forming apparatus according to claim 15,
wherein, in a case where the job includes a color image, when it is determined that the coverage of the image included in the job is high and is greater than a first predetermined color coverage value, the controller determines to change the sample discharge interval to a smaller value, and when it is determined that the coverage is low and is equal to or less than a second predetermined color coverage value (where the first predetermined color coverage value is equal to or greater than the second predetermined color coverage value), the controller determines to change the sample discharge interval to a larger value.

18. The image forming apparatus according to claim 1,
wherein, during a change in the sample discharge interval, when the sample discharge interval is set to a sheet number cycle, the controller changes a cyclic number of sheets, and when the sample discharge interval is set to a copy-page cycle, the controller changes a cyclic number of copies, or the cyclic number of copies and the page cycle.

19. The image forming apparatus according to claim 1,
wherein the controller performs control such that an operation of making a sample discharge interval change process available and an operation of making the sample discharge interval change process unavailable can be selected.

20. The image forming apparatus according to claim 1,
wherein the controller changes the sample discharge interval immediately after it is determined that the sample discharge interval is changed or when an instruction is received from an operator.

21. The image forming apparatus according to claim 1, further comprising:
an operation unit that receives an operation input,
wherein the controller performs control such that the sample discharge interval can be set by the operation unit.

22. An image forming method of forming an image on a sheet on the basis of a job and enabling a sample discharge when the job is executed, the method comprising:
acquiring information related to the image; and determining whether to change a sample discharge interval which is set in the sample discharge on the basis of the information related to the image.
